(19) United States
(12) Patent Application Publication
(10) Pub. No.: US 2026/0126954 A1
(43) Pub. Date: May 7, 2026

(54) METHOD FOR INTERACTING VOICE, ELECTRONIC DEVICE AND STORAGE MEDIUM

(71) Applicant: Beijing Baidu Netcom Science Technology Co., Ltd., Beijing (CN)

(72) Inventors: Zhiheng XU, Beijing (CN); Pengfei ZHONG, Beijing (CN); Xiaohua REN, Beijing (CN); Xiaolin HUANG, Beijing (CN); Huibin ZHAO, Beijing (CN)

(73) Assignee: Beijing Baidu Netcom Science Technology Co., Ltd., Beijing (CN)

(21) Appl. No.: 19/427,993

(22) Filed: Dec. 19, 2025

(30) Foreign Application Priority Data
Mar. 7, 2025 (CN) 202510272830.8

(51) Int. Cl. G06F 3/16; G06F 40/205; G06F 40/30

(52) U.S. Cl. CPC G06F 3/167; G06F 40/205; G06F 40/30

(57) ABSTRACT

A method for interacting voice is provided. The method includes: determining a user included in a physical environment and a first position of the user in the physical environment based on a real-time audio stream collected in the physical environment; presenting a user indicator corresponding to the user in association with a target indicator in a voice interaction interface rendered for the physical environment, where the relative positional relationship between the user indicator and the target indicator is determined based on the relative positional relationship between the first position and a second position corresponding to the target indicator in the physical environment; and adjusting a visual presentation attribute of the user indicator based on a portion of the real-time audio stream corresponding to the user.

### CROSS-REFERENCE TO RELATED APPLICATIONS

This application claims the priority from Chinese Patent Application No. 202510272830.8, filed on Mar. 7, 2025, the entire disclosure of which is hereby incorporated by reference.

### TECHNICAL FIELD

The present disclosure relates to the field of computer technology, and in particular to the technical fields of artificial intelligence such as speech recognition, audio processing, computer vision, and large language models, and more particularly to a method for interacting voice based on a large language model, an apparatus, an electronic device, a computer-readable storage medium, and a computer program product.

### BACKGROUND

In work and life, when people handle complex tasks or matters requiring multi-person collaboration, they usually adopt meetings to communicate and discuss the tasks and matters. Correspondingly, centralized discussions through meetings can improve the processing quality and efficiency of tasks and matters.

In this context, how to help people conduct meetings more efficiently and with better experience, and facilitate people to track and review the communication and interaction behaviors occurring during meetings, is a matter worthy of attention and an urgent demand.

### SUMMARY

Embodiments of the present disclosure propose a method for interacting voice based on a large language model, an electronic device, and a computer-readable storage medium.

In a first aspect, an embodiment of the present disclosure proposes a method for interacting voice based on a large language model, including: determining a user included in a physical environment and a first position of the user in the physical environment based on a real-time audio stream collected in the physical environment; presenting a user indicator corresponding to the user in association with a target indicator in a voice interaction interface rendered for the physical environment, where the relative positional relationship between the user indicator and the target indicator is determined based on the relative positional relationship between the first position and a second position corresponding to the target indicator in the physical environment; and adjusting a visual presentation attribute of the user indicator based on a portion of the real-time audio stream corresponding to the user.

In a second aspect, an embodiment of the present disclosure provides an electronic device, including: at least one processor; and a memory communicatively connected to the at least one processor; where the memory stores instructions executable by the at least one processor, and the instructions are executed by the at least one processor to enable the at least one processor to implement the method for interacting voice based on a large language model described in any implementation manner of the first aspect.

In a third aspect, an embodiment of the present disclosure provides a non-transitory computer-readable storage medium storing computer instructions, where the computer instructions are configured to cause a computer to implement the method for interacting voice based on a large language model described in any implementation manner of the first aspect when executed.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

By reading the detailed description of non-limiting embodiments with reference to the following drawings, other features, purposes, and advantages of the present disclosure will become more apparent:

FIG. 1 is an exemplary system architecture to which the present disclosure may be applied;

FIG. 2 is a flowchart of a voice interaction process based on a large language model according to an embodiment of the present disclosure;

FIG. 3 is a flowchart of a process for determining identity information corresponding to a user according to an embodiment of the present disclosure;

FIGS. 4a-4h are schematic diagrams of effects of a voice interaction interface according to embodiments of the present disclosure respectively;

FIG. 5 is a schematic diagram of an effect achieved by a voice interaction process based on a large language model in an application scenario according to an embodiment of the present disclosure;

FIG. 6 is a structural block diagram of an apparatus for interacting voice based on a large language model according to an embodiment of the present disclosure;

FIG. 7 is a structural schematic diagram of an electronic device adapted for executing the method for interacting voice based on a large language model according to an embodiment of the present disclosure.

### DETAILED DESCRIPTION OF EMBODIMENTS

The exemplary embodiments of the present disclosure will be described below with reference to the accompanying drawings, including various details of the embodiments of the present disclosure to facilitate understanding, which should be regarded as merely exemplary. Therefore, those of ordinary skill in the art should recognize that various changes and modifications can be made to the embodiments described herein without departing from the scope and spirit of the present disclosure. Similarly, for clarity and conciseness, descriptions of well-known functions and structures are omitted in the following description. It should be noted that the embodiments in the present disclosure and the features in the embodiments can be combined with each other without conflict.

In addition, in the technical solutions involved in the present disclosure, the acquisition, storage, use, processing, transportation, provision, and disclosure of user personal information (such as the real-time audio stream involved later in the present disclosure) all comply with relevant national laws and regulations and do not violate public order and good customs.

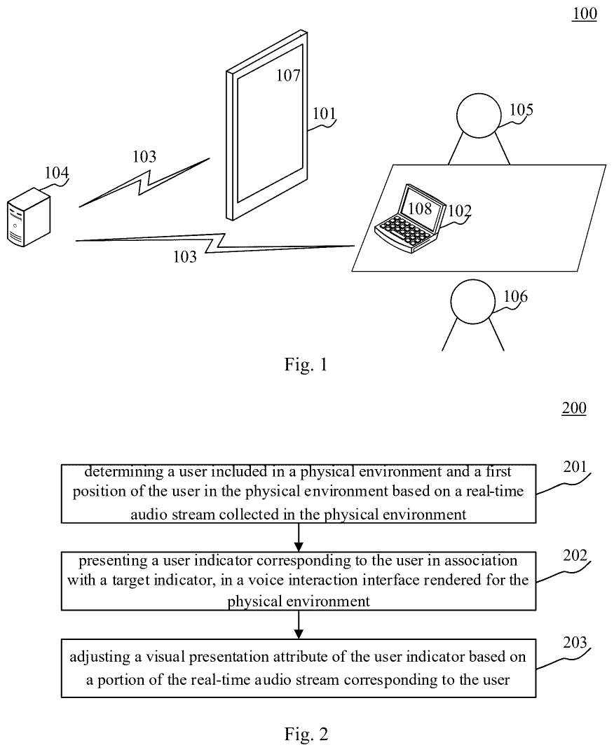

FIG. 1 shows an exemplary system architecture 100 of embodiments to which a method and an apparatus for interacting voice based on a large language model, an electronic device, and a computer-readable storage medium according to the present disclosure may be applied.

As shown in FIG. 1, the system architecture 100 may include at least terminal devices 101 and 102. For example, the terminal devices 101 and 102 may be arranged in a meeting environment or used in a meeting environment, such as hardware devices with computing and processing capabilities like smart screens, tablet computers, and laptop computers. In some scenarios, the terminal devices 101 and 102 may also be software. When the terminal devices 101 and 102 are software, they may be implemented as multiple software pieces or software modules, or as a single software piece or software module, which is not specifically limited herein.

In some embodiments, the system architecture 100 may further include a network 103 and a server 104. The network 103 is used to provide a medium for communication links between the terminal devices 101, 102 and the server 104. The network 103 may include various connection types, such as wired, wireless communication links, or optical fiber cables.

Similarly, the server 104 may also be hardware or software. When the server 104 is hardware, it may be implemented as a distributed server cluster composed of multiple servers, or as a single server; when the server is software, it may be implemented as multiple software or software modules, or as a single software or software module, which is not specifically limited herein.

In such a case, the system architecture 100 may actually use the server 104 to provide computing power for the terminal devices 101 and 102, and use the terminal devices 101 and 102 as “presentation terminals” to present the processing results of the server 104.

For example, in the above meeting scenario, the system architecture 100 may actually use the terminal devices 101 and 102 as “presentation terminals” to provide voice interaction interfaces 107 and 108 for users 105 and 106, respectively, so that the users 105 and 106 can use the voice interaction interfaces 107 and 108 to obtain the processing results of the server 104.

For ease of understanding, the system architecture 100 including the server 104 is taken as an example. In such a case, the users 105 and 106 may use the terminal devices 101 and 102 to interact with the server 104 through the network 103 to receive or send messages. Various applications for realizing information communication between the terminals and the server may be installed on the terminal devices 101, 102 and the server 104, such as meeting assistant applications, meeting recording applications, instant messaging applications, etc.

Correspondingly, the server 104 may also provide various services through various built-in applications. Taking a meeting assistant application that can provide meeting process recording and presentation as an example, the server 104 can achieve the following effects when running the meeting assistant application: first, the server 104 obtains a real-time audio stream collected based on the physical environment from the terminal devices 101 and 102 through the network 103, and determines a user included in the physical environment and a first position of a user in the physical environment; then, the server 104 presents a user indicator corresponding to the user in association with a target indicator in a voice interaction interface rendered for the physical environment, where the relative positional relationship between the user indicator and the target indicator is determined based on the relative positional relationship between the first position and a second position corresponding to the target indicator in the physical environment; finally, the server 104 adjusts a visual presentation attribute of the user indicator based on a portion of the real-time audio stream corresponding to the user.

Since operations such as determining the user included in the physical environment and the first position of the user in the physical environment may require occupying a lot of computing resources and strong computing capabilities, the method for interacting voice based on a large language model according to the subsequent embodiments of the present disclosure is generally executed by the server 104 with strong computing capabilities and a lot of computing resources. Correspondingly, the apparatus for interacting voice based on a large language model is generally also arranged in the server 104. However, it should also be pointed out that when the terminal devices 101 and 102 also have the required computing capabilities and computing resources, the terminal devices 101 and 102 can also complete the above operations entrusted to the server 104 through the meeting assistant application installed thereon, and then output the same results as the server 104. Especially when there are multiple terminal devices with different computing capabilities, but the meeting assistant application determines that the terminal device where it is located has strong computing capabilities and more remaining computing resources, the terminal device may be allowed to execute the above operations, thereby appropriately reducing the computing pressure of the server 104. Correspondingly, the apparatus for interacting voice based on a large language model may also be arranged in the terminal devices 101 and 102. For example, considering convenience and other needs, when the computing capabilities and computing resources provided by the terminal devices 101 and 102 may also meet the requirements of the above operations, the terminal devices 101 and 102 can directly complete the above operations entrusted to the server 104. Correspondingly, the exemplary system architecture 100 may not include the network 103 and the server 104.

It should be understood that the number of terminal devices, networks, and servers in FIG. 1 is merely schematic. There may be any number of terminal devices, networks, and servers according to implementation needs.

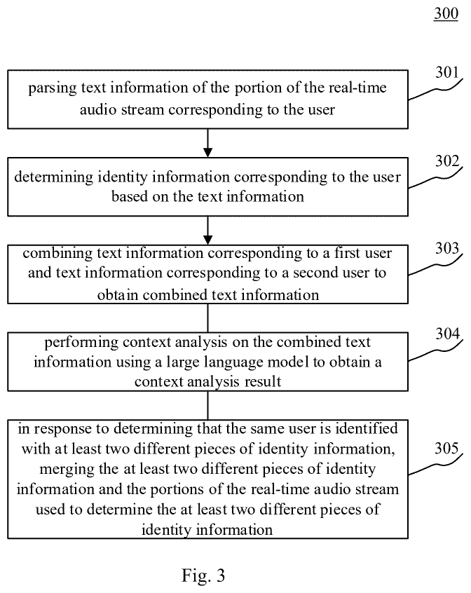

Please refer to FIG. 2. FIG. 2 is a flowchart of a voice interaction process based on a large language model according to an embodiment of the present disclosure, which includes a process 200.

The process 200 specifically includes the following steps.

Step 201 includes: determining a user included in a physical environment and a first position of the user in the physical environment based on a real-time audio stream collected in the physical environment;

In an embodiment of the present disclosure, for ease of understanding, the execution entity of the method for interacting voice based on a large language model may be directly implemented by, for example, the terminal devices 101 and 102 shown in FIG. 1. For example, the terminal devices 101 and 102 may be “smart screens” arranged in a meeting environment with required computing capabilities and computing resources.

In this step, the execution entity may determine a user included in the physical environment and the position of the user in the physical environment (referred to as “first position” for convenience of description) based on the real-time audio stream collected in the physical environment. For example, the physical environment may be a real “meeting environment”, and in such a meeting environment, users such as users 105 and 106 may realize a “meeting” through communication and interaction between users.

In this embodiment, the real-time audio stream may be obtained by a sound collection device such as a microphone configured in the execution entity through sound collection of the physical environment.

In some embodiments, the real-time audio stream may also be collected by a sound collection device that is deployed in the physical environment, configured independently of the execution entity, and capable of communicating with the execution entity (for example, a microphone set independently of a “smart screen”). Accordingly, after capturing the real-time audio stream, the execution entity may parse the stream to identify a user included in the physical environment and determine a first position of the user within that environment.

Generally, the execution entity may at least parse the “tone” and “timbre” included in the real-time audio stream through, for example, “tone” and “timbre” standards, and then correspondingly determine the user involved and included in the real-time audio stream according to different “tones”and “timbres”.

In some embodiments, a user may pre-register his or her own timbre with the execution entity, allowing the entity to “recognize the user” more efficiently and accurately by timbre later on. This approach not only improves the accuracy of user identification and differentiation, but also reduces the computational cost incurred by the execution entity when performing the parsing operation.

During this process, the execution entity may also determine the first position of the user in the physical environment through sound source positioning while parsing the real-time audio stream.

It should be understood that the collection of the real-time audio stream may start according to a user action instruction (for example, clicking a specific control or making a specific gesture). Correspondingly, if no sound signal is detected in the physical environment, the execution entity may first choose to enter a waiting state and continuously detect until a sound signal is found.

Step 202 includes: presenting a user indicator corresponding to the user in association with a target indicator, in a voice interaction interface rendered for the physical environment.

In embodiments of the present disclosure, the execution entity may render a voice-interaction interface that corresponds to the physical environment. For example, when a meeting-assistant application is launched, the execution entity may pre-generate and present such an interface so that information can be fed back to the user through it. Because the interface is produced automatically by the execution entity, this approach reduces the amount of prior configuration required from the user, lowers interaction complexity, and improves the overall user experience.

In the voice interaction interface, the position of the user in the physical environment and the relative positions among users may be presented through users indicators corresponding to the users. Moreover, since the user indicator corresponds to a user (in other words, a user may have his or her own “user indicator”), the interaction status of the user may also be presented through the user indicator. For example, the speaking and interaction status of the user may be fed back and presented by adjusting the visual style of the user indicator, adding dynamic effects, etc.

Correspondingly, to better present the layout between users, the pre-generated and formed voice interaction interface by the execution entity may further include a target indicator. The target indicator corresponds to an actual spot in the physical environment (referred to as “second position” for convenience of description). Thus, the execution entity uses the target indicator as an anchor point to determine the layout of the user indicators and present the layout between users. For example, the target indicator may be a circular icon for marking the “second position” in the voice interaction interface.

In other words, the target indicator may be used as a positioning reference to present the layout of the user indicators. That is, the execution entity may simulate and present the relative positional relationship between the first position where the user is located in the physical environment and the second position based on the target indicator and the user indicator.

In some embodiments, the second position may actually be the position where a sound collection device (which may be a sound collection device arranged inside the execution entity or a sound collection device independent of the execution entity) is arranged in the physical environment. Thus, the user can understand his or her relative position relative to the sound collection device through the voice interaction interface and adaptively adjust the interaction strategy (for example, whether to approach or move away from the sound collection device, etc.).

Correspondingly, in this step, if the execution entity identifies a user (for the first time) based on the real-time audio stream, the execution entity may present a user indicator corresponding to the user in association with the target indicator in the voice interaction interface rendered for the physical environment. As described above, the relative positional relationship between the user indicator and the target indicator may be determined based on the relative positional relationship between the first position and the second position corresponding to the target indicator in the physical environment.

In practice, for a position of adding the user indicator in the voice interaction interface, a relationship between the first position and the second position may be completely referred to and restored for the direction of the user indicator, and the distance between the user indicator and the target indicator in the voice interaction interface may be determined through proportional scaling of the distance between the first position and the second position.

In some optional implementations of this embodiment, the distance between the user indicator and the target indicator presented in the voice interaction interface may also be pre-configured with a maximum distance value (that is, if the determined distance between the user indicator and the target indicator in the voice interaction interface exceeds the maximum distance value, the maximum distance value is actually used as the distance) to avoid the overall layout being scattered due to the user indicator being too far away and affecting the viewing experience.

It should be understood that the visual styles of the user indicator and the target indicator may be identical icons, such as both being “circular icons”, or different icons, such as the target indicator being “circular” and the user indicator being “triangular”, etc. Similarly, in some scenarios, the user indicator and the target indicator may also be distinguished by different colors, which will not be repeated here.

Step 203 includes: adjusting a visual presentation attribute of the user indicator based on a portion of the real-time audio stream corresponding to the user.

In an embodiment of the present disclosure, after completing the addition of the user indicator based on the above step 202, the execution entity may adjust the visual presentation attribute of the user indicator based on the portion of the real-time audio stream corresponding to the user (that is, the portion of the real-time audio stream belonging to the user, or the sub-real-time audio stream) to specifically and real-timely respond to and feed back the meeting interaction status of the user through changes in visual attributes such as the visual style, visual elements, color, size, and presentation position of the user indicator.

For example, for the speaking behavior of the user in the real-time audio stream, the execution entity may choose to provide a new visual effect different from the original visual effect by rotating the user indicator, highlighting the user indicator, changing the color of the user indicator, etc., so that the user can understand the meeting status of the user by observing the changes in the visual attributes of the user indicator in the voice interaction interface. For example, if the user indicator is (continuously) rotating, it indicates that the corresponding user is “speaking”.

The method for interacting voice based on a large language model according to the embodiment of the present disclosure first determines a user included in a physical environment and a first position of the user in the physical environment based on a real-time audio stream collected in the physical environment; then presents a user indicator corresponding to the user in association with a target indicator in a voice interaction interface rendered for the physical environment, where the relative positional relationship between the user indicator and the target indicator is determined based on the relative positional relationship between the first position and a second position corresponding to the target indicator in the physical environment; and finally adjusts a visual presentation attribute of the user indicator based on a portion of the real-time audio stream corresponding to the user. Thus, users can more intuitively and conveniently understand the interaction status and situation between users in a meeting, reducing the interaction complexity for users and improving the user experience.

In some embodiments, during the process of the execution entity determining a user included in the physical environment and the first position of the user in the physical environment (for example, during the execution of the above step 201), the execution entity may first use a time difference of arrival (TDOA) positioning algorithm to determine the source direction and distance of a voice signal in the real-time audio stream collected in the physical environment.

The TDOA positioning algorithm is a technology that determines the position of a signal source by calculating the difference in arrival time of a signal at different receiving stations. The TDOA positioning algorithm can calculate the source position of the voice signal by measuring the time difference of the voice signal from the transmitting source to different receiving points.

Then, the execution entity may determine the users included in the physical environment based on the source direction (for example, determining the users based on corresponding different directions and different timbres). For example, the execution entity may compare the arrival times of different sound source signals (that is, voice signals) through the TDOA positioning algorithm, and then calculate the source direction and distance of the voice signal in the physical environment.

Finally, the execution entity determines a first position of a user in the physical environment based on the distance. Thus, the execution entity may use the TDOA positioning algorithm to more accurately locate, identify, and split users.

In some embodiments, as discussed above, the physical environment such as a meeting environment may include at least two or more users. In such a case, the execution entity may also respond to this situation by parsing a corresponding portion of each user in the real-time audio stream through, for example, blind source separation (BSS) to split the “real-time audio stream” and determine a respective “portion” and a respective “sub-real-time audio stream” of each user.

Blind source separation is a technology that recovers independent source signals from multiple mixed signals, using only the received mixed signals. Correspondingly, the use of blind source separation can enable the execution entity to independently process real-time audio streams involving multiple users to solve the problem of voice mixing when multiple users speak simultaneously, ensuring that the voice content of each user can be accurately identified and personalized responses can be made.

For the portion of the real-time audio stream corresponding to the user (or in the case of multiple users, for a respective corresponding portion of the real-time audio stream with respect to each user), the execution entity may choose to parse the (voice) content of the portion to determine the text information of the content included in the portion (that is, the “content” in text form). For example, the portion of the real-time audio stream corresponding to the user may be converted into corresponding text information based on automatic speech recognition (ASR) technology.

Then, the execution entity may determine the identity information corresponding to each user based on the text information. The identity information may specifically be the user name (for example, the user has previously provided the name to the execution entity through authorization and entry), or may only be positioned to the user role. For example, such identity information may be Speaker 1, Speaker 2, or Participant 1, Participant 2, etc. For example, the execution entity may determine the corresponding identity information (for example, host, explainer, questioner, etc.) based on the semantic information summarized from the text information.

Next, the execution entity may further present an identity prompt in association with the user indicator corresponding to the user based on the identity information corresponding to the user. For example, the visual style of the identity prompt may be text information corresponding to the identity information.

Thus, this enables the execution entity to not only recognize the content of the voice but also identify the speaking user according to the spatial position of the voice signal, ensuring personalized responses in a multi-user environment. Moreover, through the identity prompt, users can more intuitively and effectively determine the participants and their identities and roles in the meeting.

In some embodiments, to avoid user identification errors caused by inaccurate positioning, timbre errors, etc., for example, identifying speech and interaction of one user as those of two or more users, the execution entity may also choose to determine whether there is a case where a same user is identified with at least two different pieces of identity information.

Correspondingly, if a same user is identified with at least two different pieces of identity information, the execution entity may respond to this by merging the at least two different pieces of identity information (for example, adjusting the subsequent identity information to the first determined “identity information” to complete the merging) and merging the portions of the real-time audio stream used to determine the at least two different pieces of identity information (for example, merging “portions” previously incorrectly split and extracted from real-time audio streams into a whole). Thus, response confusion caused by user positioning and identification errors is avoided.

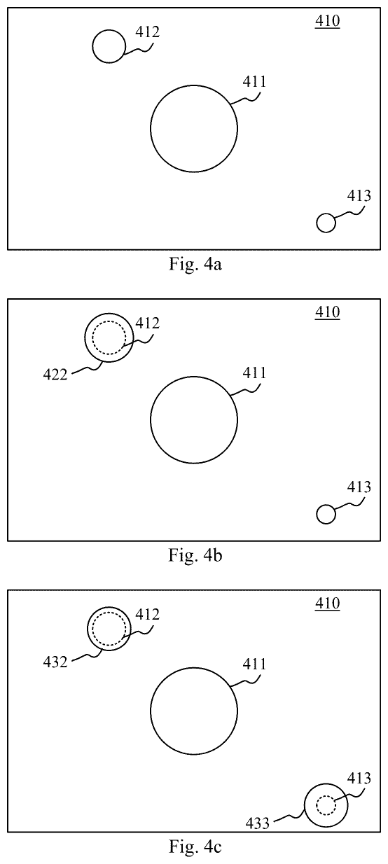

For ease of understanding, above embodiment may be described with reference to FIG. 3. FIG. 3 is a flowchart of a process for determining identity information corresponding to a user according to an embodiment of the present disclosure, which includes a process 300.

The process 300 specifically includes the following steps.

Step 301 includes: parsing text information of the portion of the real-time audio stream corresponding to the user.

Step 302 includes: determining identity information corresponding to the user based on the text information.

As discussed above, in steps 301 and 302, the execution entity may first parse the text information based on the automatic speech recognition technology, and then determine the identity information corresponding to each user based on the identity information, which will not be repeated here.

Step 303 includes: combining text information corresponding to a first user and text information corresponding to a second user to obtain combined text information.

Specifically, as discussed above, if the execution entity detects the existence of at least two “users”, the execution entity may select any two “users” as the first user and the second user, and combine the text information corresponding to the first user and the text information corresponding to the second user to obtain the combined text information.

Step 304 includes: performing context analysis on the combined text information using a large language model to obtain a context analysis result.

Specifically, on the basis of the above step 303, the execution entity may use a large language model to perform context analysis on the combined text information to determine whether the combined information belongs to a “complete event” explained and stated by a given person in terms of semantics analyzed through context, whether the combined information comes from the given person in terms of context, and correspondingly obtain the context analysis result.

Large Language Model (LLM) is an artificial intelligence model designed to understand and generate human language, and the LLM can correspondingly perform processing operations based on the content it understands to obtain corresponding processing results. For example, after obtaining the “combined text information”, the LLM may determine whether the combined text information comes from and belongs to a given person (or user) based on its understanding of the instruction (for example, identifying whether the combined text information comes from the given person) and its semantic understanding and processing of the combined text information.

Typically, the LLM may be trained based on a large amount of text data and may perform a wide range of tasks, including text summarization, translation, sentiment analysis, etc. The LLM is characterized by its large scale, usually including a large number of parameters to help learning complex patterns in language data. The LLM is usually based on deep learning architectures, such as transformers, which help it to provide better processing performance on various NLP tasks.

In addition, for the LLM model, it can omit the “guide word” through a default configuration. For example, after obtaining the “combined text information”, for the purpose of determining whether the combined text information comes from a given person based on its semantic understanding and processing of the combined text information, the LLM may naturally understand the operation to be performed on the input “combined text information” (that is, determining whether the combined text information comes from the given person) based on the default configuration. Thus, through the default configuration, the generative model may stably and directionally process the combined text information, and the efficiency of using the generative large language model is improved.

Correspondingly, the context analysis result may indicate whether the first user and the second user are the same user with different identity information. For example, if the combined information belongs to a “complete event” explained and stated by the given person, the context analysis result may indicate that the first user and the second user are actually the “same user”.

Step 305 includes: in response to determining that the same user is identified with at least two different pieces of identity information, merge the at least two different pieces of identity information and the portions of the real-time audio stream used to determine the at least two different pieces of identity information.

Specifically, as discussed above, in this step, the execution entity may perform a “merging” action when determining that the same user is identified with at least two different pieces of identity information (for example, determining that the same user is identified with at least two different pieces of identity information based on the context analysis result obtained in step 304), which will not be repeated here.

Thus, on the basis of integrating context information, a large language model is used for deeper understanding and dialogue management.

It should be understood that in the embodiment using the large language model, the execution entity may also choose to entrust one or more tasks among parsing text information, determining identity information, and combining text information to the large model for processing. Thus, while making more full use of the computing power of the large language model, the model can also enable the processing parameters of these tasks to be learned by the large language model and used for reference in other tasks, so that the large language model can complete the processing of these tasks in a more consistent style, reducing the result and style fragmentation that may be caused by model crossing.

In some embodiments, to make more full use of the computing power of the large language model, the execution entity may also entrust the step of parsing the real-time audio stream as discussed above to the large language model for processing. For example, during the execution of the above step 201, the execution entity may actually choose to call the large language model to determine the user included in the physical environment and the first position of the user in the physical environment based on the real-time audio stream collected in the physical environment. For example, the large language model may similarly use the TDOA positioning algorithm or other algorithms to parse the real-time audio stream to determine the users included in the physical environment and the first position of each user in the physical environment.

For another example, the process of “adjusting the visual presentation attribute of the user indicator” to be discussed and described later may also be implemented by the large language model (for example, using the large language model to generate a dynamic user indicator, and generate a user indicator with a changed size, to realize the adjustment of the “size”, etc.).

It should be understood that after completing one round of user merging, the user obtained after the merging may still be determined whether the user can continue to merge with other “users” in a similar way. Thus, through such “continuous merging”, the portions of the real-time audio stream belonging to a same user can be continuously integrated. Through such continuous integration, the execution entity can ensure the continuity and fluency of information exchange in the dialogue, avoiding information confusion, interruption, or restart.

In some embodiments, the execution entity may also choose to continuously track and store the text information of each user and the corresponding portion of the real-time audio stream. Thus, by retaining the dialogue context and interaction records of each user, the execution entity can better understand the previous inputs and needs of the user, thereby better understanding and responding in subsequent interactions (for example, in some embodiments, the execution entity may also provide users with personalized response services such as online Q&A and task processing through the large language model), and further avoid incoherent dialogue and information confusion.

In some optional implementations of this embodiment, if the execution entity is configured and selected to determine the user identity information, in such a case, for the “target indicator”, a target user with a specific identity may also be selected as the “anchor point”. For example, the position of the “target indicator” in the physical environment may actually be the position of the target user with identity information such as “speaker” and “host”. That is, the above second position may be the position of the target user in the physical environment in addition to the position where the sound collection device is arranged in the physical environment.

Thus, the execution entity may present the environment (or meeting layout) by referring to the position of the target user with specific identity information in the physical environment, so that the execution entity can construct the voice interaction interface based on the interaction mode between users (for example, the mode of speaker and audience), highlighting the “interaction sense” corresponding to the interaction mode between users.

In some embodiments, for the above target indicator, its presentation position may be located at the center of the voice interaction interface. That is, the execution entity may choose to present the target indicator at the center of the voice interaction interface.

Thus, the user layout expanded around the target indicator in the voice interaction interface may be overall located at the center of the voice interaction interface, avoiding the user indicator from being excessively offset and affecting the user viewing experience, and improving the user experience.

In some embodiments, to give the user a more “immersive” experience, the execution entity may also refer to the physical environment when forming the voice interaction interface to improve the user experience.

Specifically, during the prior process of forming the voice interaction interface, the execution entity may choose to form the voice interaction interface based on the planar layout of the physical environment. For example, the execution entity may determine the planar layout of the physical environment through a layout template and/or layout diagram of the physical environment selected and provided by the user, or the execution entity may determine the three-dimensional layout of the physical environment through a collection device such as a camera and determine the planar layout based on the three-dimensional layout. Then, the execution entity forms the voice interaction interface based on the planar layout (for example, directly using the planar layout or using the planar layout after proportional reduction).

Thus, the voice interaction interface constructed based on the real situation of the physical environment can more truly feed back the situation during the meeting, facilitate the user to more effectively read information such as positions, and improve the user experience.

In some optional implementations of this embodiment, in such a case, for the “target indicator”, the execution entity may determine the planar position of the second position corresponding to the target indicator in the physical environment in the planar layout. Then, the position where the target indicator is presented in the voice interaction interface is determined and presented through a mapping manner based on the planar position. Thus, the layout of the target indicator and the user indicator can be closer to the “real situation” in the physical environment.

In some embodiments, if there is a previously formed voice interaction interface before audio collection, the execution entity may additionally choose to present some “sound collection indicators” in such an interface. Correspondingly, after presenting the “sound collection indicators”, during the process of collecting the real-time audio stream, the execution entity may also feed back the real-time audio stream collection process by changing the visual style of the “sound collection indicators” (for example, “geometric balls” that adaptively change based on timbre, tone, speech rate, etc.).

Next, the adjustment manner of the execution entity for the visual presentation attribute of the user indicator will be further discussed in multiple embodiments.

In some embodiments, when adjusting the visual presentation attribute of the user indicator, the execution entity may choose to continuously adjust the size of the user indicator based on the accumulated number of words of the text information of the portion of the real-time audio stream corresponding to the user. The size is positively correlated with the accumulated number of words.

That is, the execution entity may adjust the size (among the visual presentation attributes of) the user indicator with reference to the “cumulative amount of speaking content” of the user. For example, as the accumulated number of words output by the user increases, the size of the user indicator correspondingly gradually increases. Thus, the cumulative amount of words output by the user during the interaction can be intuitively understood through the size of the user indicator.

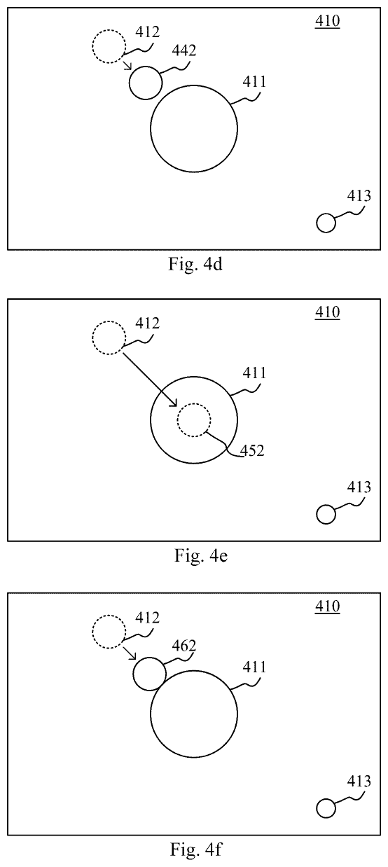

For ease of understanding, the process and effect of the adjustment manner involved in the embodiments may be described with reference to FIGS. 4a-4h together. FIGS. 4a-4h are all schematic diagrams of effects of a voice interaction interface according to embodiments of the present disclosure.

FIG. 4a includes a voice interaction interface 410 (for example, the interface may actually be the voice interaction interface 107 provided by the terminal device 101 and/or the voice interaction interface 108 provided by the terminal device 102). The voice interaction interface 410 includes a target indicator 411, a user indicator 412 corresponding to the user 105, and a user indicator 413 corresponding to the user 106. For ease of understanding, FIG. 4a may be simply understood as an “initial state” where the user indicators 412 and 413 have just been added and no adjustment has been made to the “user indicator 412” and the “user indicator 413”.

Exemplarily, the “user indicator 412” may have a larger size because the user 105 is closer to the “second position” corresponding to the target indicator 411 in the physical environment than the user 106.

Next, reference may be made to FIG. 4b. In FIG. 4b, the user indicator 412 may be adjusted by the execution entity to a user indicator 422 as the user 105 speaks more and the accumulated number of words increases. The size of the user indicator 422 is larger than that of the user indicator 412.

In some optional implementations of this embodiment, during the process of adjusting the size based on the accumulated number of words, an upper limit size may also be selected to be set to avoid the user indicator from expanding indefinitely and causing chaos in the layout of the voice interaction interface. For example, the execution entity may set an accumulation threshold to correspond to the upper limit size, so that the execution entity no longer continues to “expand” and “enlarge” the size when determining that the accumulated number of words reaches the accumulation threshold.

That is, the execution entity may respond when determining that the accumulated number of words is greater than or equal to the accumulation threshold, and stop continuously adjusting the size of the user indicator.

In some embodiments, the execution entity may also adjust the size of the user indicator based on the volume level of the portion of the real-time audio stream corresponding to the user. The size is positively correlated with the volume. For example, the execution entity may set a scaling factor and determine the actual enlarged size based on a product of the volume level and the scaling factor.

In some optional implementations of this embodiment, the execution entity may also determine a magnification factor based on the volume level and apply “multiply” or “divide” operations to resize the indicator. This avoids inconsistent enlargement logic caused by different original sizes—for example, preventing a user indicator that started smaller from being “over-enlarged” when the same fixed increment is added.

Thus, the speaking volume of the user can be intuitively reflected by the size of the user indicator.

Next, reference may be made to FIG. 4c. In FIG. 4c, the execution entity may adjust the user indicator 412 and the user indicator 413 due to the speaking behavior of the users 105 and 106 (for example, the user indicator 412 is adjusted to a user indicator 432, and the user indicator 413 is adjusted to a user indicator 433). During this process, exemplarily, the execution entity may further determine that the adjustment amplitude (e.g., magnification factor) applied to user indicator 413 is greater than that applied to user indicator 412, because the speaking volume of the user 106 is higher than that of user 105.

In addition, the execution entity may also, based on the user (historical or current) speaking behavior, adjust the position (among the visual presentation attributes) of the corresponding user indicator, so that the movement of the user indicator presents the user interaction status such as speaking. Accordingly, users can understand the meeting interaction status of a user—such as the cumulative word count generated due to speaking—through changes in the position of the user indicator.

In some embodiments, when adjusting the visual presentation attribute of the user indicator, the execution entity may choose to continuously adjust the presentation position of the user indicator to move toward the target indicator based on the accumulated number of words of the text information of the portion of the real-time audio stream corresponding to the user. The moving distance of the presentation position of the user indicator is positively correlated with the accumulated number of words.

That is, the user indicator may gradually and continuously move toward the target indicator as the accumulated number of words output by the user increases.

Next, please refer to FIG. 4d. In FIG. 4d, as user 105 speaks more—i.e., as the cumulative word count increases—user indicator 412 is moved by the execution entity in the direction pointing toward target indicator 411, and is thus adjusted from user indicator 412 to user indicator 442.

In some optional implementations of this embodiment, during the process of moving the user indicator based on the accumulated number of words, the presentation position of the target indicator may be selected as the upper limit position of the movement. That is, if the execution entity determines that such continuous movement makes the presentation position of the user indicator the same as the presentation position of the target indicator, the execution entity may respond to this and stop continuously adjusting the presentation position of the user indicator to move toward the target indicator.

In this way, the visual effect of the user indicator “gradually merging into and blending with” the target indicator is achieved, so that the positional relationship between the user indicator and the target indicator can intuitively present the user meeting-participation and interaction status and progress, thereby improving user experience.

In this regard, reference may be made to FIG. 4e. In FIG. 4e, after the user indicator 412 moves in the direction toward the target indicator 411 as shown in FIG. 4d, the execution entity may stop further movement once its presentation position reaches the target indicator 411 (e.g., when the geometric centers of the two overlap). Consequently, under such circumstances, the user indicator 412 is finally adjusted to become the user indicator 452 (illustratively, the user indicator 452 becomes “not directly visible” because it has merged into the target indicator 411).

In some optional implementations of this embodiment, when the user indicator is allowed to merge into and blend with the target indicator, the execution entity may, during each stage from the beginning of blending to the ongoing fusion, render fusion-specific visual effects based on the fusion position. In this way, the presented merging process becomes more “natural” and enhances the user viewing experience.

In other embodiments, the upper-limit position for moving the user indicator based on the accumulated number of words may, according to different needs, be defined as “any overlap between the user indicator and the target indicator.” That is, in these alternative embodiments, the execution entity may also choose to stop continuously adjusting the presentation position of the user indicator toward the target indicator as soon as an overlap between the two is detected.

In this way, the user indicator is rendered in a more independent and distinct manner during the movement, satisfying varying demands of different users for “clarity” and “intuitiveness.”

In this regard, reference may be made to FIG. 4f. In FIG. 4f, after the user indicator 412 has moved in the direction pointing toward the target indicator 411 as shown in FIG. 4d, the execution entity may stop further movement once a collision or overlap occurs between the user indicator 412 and the target indicator 411. Accordingly, under such circumstances, the user indicator 412 is finally adjusted to become the user indicator 462.

Similarly, the execution entity may also choose to stop moving after the user indicator has just moved to a state of being “completely merged” by the target indicator.

In some embodiments, as discussed above, the execution entity may also directly change the visual style of the user indicator to reflect the state of the user such as speaking.

Specifically, for the process of adjusting the visual presentation attribute of the user indicator based on the portion of the real-time audio stream corresponding to the user, the execution entity may choose to adjust the visual style (among the visual presentation attributes of) the user indicator to a dynamic icon in response to determining that the user is currently speaking based on the portion of the real-time audio stream corresponding to the user.

For example, the execution entity may form a dynamic icon by adding dynamic elements to the visual style of the user indicator or moving the edge shape of the visual style of the user indicator according to a preset animation rule, and present the dynamic icon.

For example, in the case where a cartoon image is used as the visual style of the user indicator, the execution entity may present a “short video” formed based on the cartoon image as the dynamic icon. Thus, the state of the user currently speaking may be intuitively fed back through the dynamic icon.

In some embodiments, with reference to the size-adjustment and position-adjustment methods discussed above, the system may, upon detecting that the user is speaking, adopt cyclical “size adjustment” and “position movement” to render the user indicator dynamic (in such a dynamic style, each cycle may start from the original position of the indicator or from the position updated by the accumulated number of words, and end at the presentation position of the target indicator).

In some embodiments, if the execution entity determines that the user is currently speaking, that is, the execution entity determines that the user is currently speaking based on the portion of the real-time audio stream corresponding to the user, the execution entity may also respond to this by choosing to present, between the user indicator and the target indicator in the voice interaction interface, a dynamic indicator starting from the presentation position of the user indicator and pointing to the presentation position of the target indicator.

For example, the dynamic indicator may be a continuously flowing arrow. In this way, such a dynamic indicator can more intuitively reflect the user interactive state of speaking.

In some optional implementations of this embodiment, the dynamic indicator may be a dynamic text stream generated based on the text information of the content being spoken by the user currently. Thus, through the dynamic text stream, the content currently being spoken by the user may also be prompted, so as to enhance the sense of interaction while providing auxiliary functions such as facilitating reading and understanding the speaking content, and reducing the user operation complexity (for example, the user can directly obtain the speaking content of other users through the dynamic text stream without additionally calling functional plug-ins such as subtitle addition plug-ins).

In this regard, reference may be made to FIG. 4g. In FIG. 4g, the user indicator 412 of the execution entity may generate a dynamic text stream 414 according to the speaking content “XXXXX” of the user 105 as the user 105 “is speaking”. Then, in the voice interaction interface 410, the execution entity may choose to present, 411 between the user indicator 412 and the target indicator 411, the dynamic text stream 414 starting from the presentation position of the user indicator 412 and pointing to the presentation position of the target indicator.

In some embodiments, the execution entity may also add a text box corresponding to the user in the voice interaction interface (usually, the presentation position of the text box may be determined based on a pre-configured interface layout, for example, the presentation position of the text box may be the edge of both sides of the voice interaction interface). The text box is used to present the text information of the portion of the real-time audio stream corresponding to the user. For example, the execution entity may provide a functional control in the voice interaction interface, so that the user can instruct the execution entity to add the text box by triggering the functional control.

The text box is used to present the text information of the portion of the real-time audio stream corresponding to the user. That is, the execution entity may set a corresponding text box for each user to present the text information of the content output by the user using the text box. Thus, it is convenient for the user themselves or others to review and assist in understanding the content generated by speeches of other users.

In this regard, reference may be made to FIG. 4h. In FIG. 4h, the execution entity (for example, in response to the above functional control being triggered) may add a text box 415 corresponding to the user 105 and a text box 416 corresponding to the user 106 in the voice interaction interface 410 to present the text content generated by the speech of the user 105 through the text box 415 and the text content generated by the speech of the user 106 through the text box 416.

In practice, the corresponding relationship between the text box and the user may also be indicated by presenting the identity information of the users 105 and 106 in the text box.

In summary, the present disclosure can simulate the real physical world through the voice interaction interface. It not only conveys the user orientation information by mapping the three-dimensional space to the two-dimensional user interface but also graphically and dynamically presents the propagation of sound in the physical world in the user interface, allowing users to more intuitively and conveniently understand the interaction status and situation between users in a meeting, reducing the interaction complexity for users and improving the user experience.

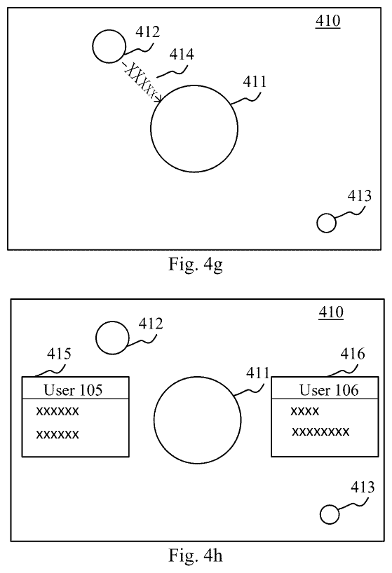

To deepen understanding, the present disclosure also provides a specific implementation scheme combined with a specific application scenario. Please refer to FIG. 5, which is a schematic diagram of an effect achieved by a voice interaction process based on a large language model in an application scenario according to an embodiment of the present disclosure. For ease of understanding, it may be described in conjunction with the system architecture 100 shown in FIG. 1.

In FIG. 5, a sound collection device 510 may collect the interaction behavior of the users 105 and 106 (that is, the speaking interaction behavior providing voice). Then, the terminal device 101 exemplarily used as the execution entity may obtain the real-time audio stream 515 collected by the sound collection device 510, and determine the users 105 and 106 and the first positions of the users 105 and 106 in the physical environment by parsing the real-time audio stream 515.

Next, the terminal device 101 presents a user indicator 522 corresponding to the user 105 and a user indicator 523 corresponding to the user 106 in association with a target indicator 521 in the voice interaction interface 107 rendered for the physical environment.

Then, the terminal device 101 adjusts the visual presentation attribute of the user indicator 522 based on the portion of the real-time audio stream 515 corresponding to the user 105 (for example, moving in the direction of the target indicator 521), and adjusts the visual presentation attribute of the user indicator 523 based on the portion of the real-time audio stream 515 corresponding to the user 106 (for example, moving in the direction of the target indicator 521).

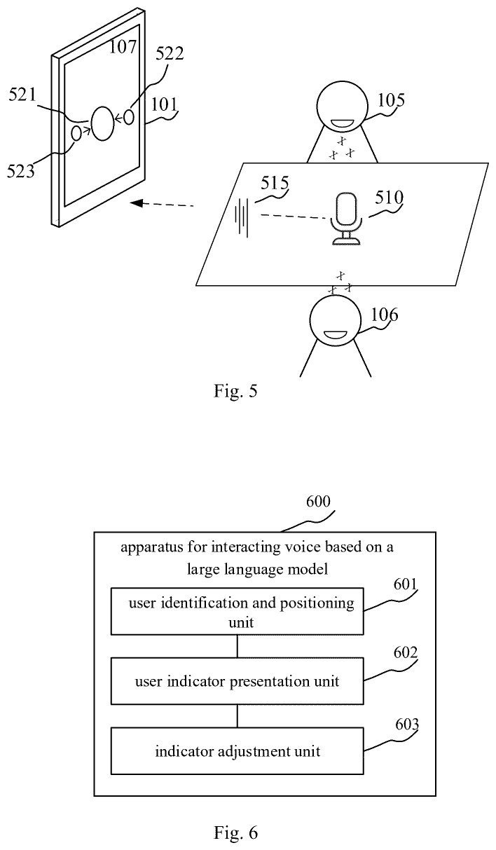

Further referring to FIG. 6, as an implementation of the methods shown in the above figures, the present disclosure provides an embodiment of an apparatus for interacting voice based on a large language model. This apparatus embodiment corresponds to the method embodiment shown in FIG. 2, and the apparatus may be specifically applied to various electronic devices.

As shown in FIG. 6, the apparatus for interacting voice 600 based on a large language model of this embodiment may include: a user identification and positioning unit 601, a user indicator presentation unit 602, and an indicator adjustment unit 603. The user identification and positioning unit 601 is configured to determine a user included in a physical environment and a first position of the user in the physical environment based on a real-time audio stream collected in the physical environment; the user indicator presentation unit 602 is configured to present a user indicator corresponding to the user in association with a target indicator in a voice interaction interface rendered for the physical environment, where the relative positional relationship between the user indicator and the target indicator is determined based on the relative positional relationship between the first position and a second position corresponding to the target indicator in the physical environment; and the indicator adjustment unit 603 is configured to adjust a visual presentation attribute of the user indicator based on a portion of the real-time audio stream corresponding to the user.

In this embodiment, in the apparatus for interacting voice 600 based on a large language model: the specific processing of the user identification and positioning unit 601, the user indicator presentation unit 602, and the indicator adjustment unit 603 and the technical effects brought thereby may be respectively referred to the relevant descriptions of steps 201-203 in the corresponding embodiment of FIG. 2, which will not be repeated here.

In some optional implementations of this embodiment, the user identification and positioning unit 601 is further configured to determine a source direction and a distance of a voice signal in the real-time audio stream collected in the physical environment using a TDOA positioning algorithm; determine the user included in the physical environment based on the source direction; and determine the first position of the user in the physical environment based on the distance.

In some optional implementations of this embodiment, the apparatus 600 further includes: a text information parsing unit configured to parse text information of the portion of the real-time audio stream corresponding to the user; an identity information determining unit configured to determine identity information corresponding to the user based on the text information; and an identity prompt presentation unit configured to present an identity prompt in association with the user indicator corresponding to the user based on the identity information corresponding to the user.

In some optional implementations of this embodiment, the apparatus 600 further includes: a user merging unit configured to merge at least two different pieces of identity information and the portions of the real-time audio stream used to determine the at least two different pieces of identity information in response to determining that a same user is identified with the at least two different pieces of identity information.

In some optional implementations of this embodiment, the apparatus 600 further includes: a text information combining unit configured to combine text information corresponding to a first user and text information corresponding to a second user to obtain combined text information, where the identity information corresponding to the first user is different from the identity information corresponding to the second user; a same-user determining unit configured to perform context analysis on the combined text information using a large language model to obtain a context analysis result, where the context analysis result indicates whether the first user and the second user are the same user with different identity information.

In some optional implementations of this embodiment, the apparatus 600 further includes: a first target indicator presentation unit configured to present the target indicator at the center of the voice interaction interface.

In some optional implementations of this embodiment, the apparatus 600 further includes: a voice interaction interface forming unit configured to form the voice interaction interface based on a planar layout of the physical environment.

In some optional implementations of this embodiment, the apparatus 600 further includes: a second target indicator presentation unit configured to determine a planar position of the second position in the planar layout; present the target indicator in the voice interaction interface based on the planar position.

In some optional implementations of this embodiment, the indicator adjustment unit 603 is further configured to continuously adjust a size of the user indicator based on an accumulated number of words of the text information of the portion of the real-time audio stream corresponding to the user, where the size is positively correlated with the accumulated number of words.

In some optional implementations of this embodiment, the apparatus 600 further includes: a size adjustment stopping unit configured to stop continuously adjusting the size of the user indicator in response to the accumulated number of words being greater than or equal to an accumulation threshold.

In some optional implementations of this embodiment, the indicator adjustment unit 603 is further configured to adjust a size of the user indicator based on a volume of the portion of the real-time audio stream corresponding to the user, where the size is positively correlated with the volume.

In some optional implementations of this embodiment, the indicator adjustment unit 603 is further configured to continuously adjust a presentation position of the user indicator to move toward the target indicator based on an accumulated number of words of the text information of the portion of the real-time audio stream corresponding to the user, where a moving distance of the presentation position of the user indicator is positively correlated with the accumulated number of words.

In some optional implementations of this embodiment, the apparatus 600 further includes: a first movement stopping unit configured to stop continuously adjusting the presentation position of the user indicator to move toward the target indicator in response to the presentation position of the user indicator being the same as the presentation position of the target indicator.

In some optional implementations of this embodiment, the apparatus 600 further includes: a second movement stopping unit configured to stop continuously adjusting the presentation position of the user indicator to move toward the target indicator in response to detecting an overlap between the user indicator and the target indicator.

In some optional implementations of this embodiment, the indicator adjustment unit 603 is further configured to adjust a visual style of the user indicator to a dynamic icon in response to determining that the user is currently speaking based on the portion of the real-time audio stream corresponding to the user.

In some optional implementations of this embodiment, the apparatus 600 further includes: a dynamic indicator presentation unit configured to present a dynamic indicator between the user indicator and the target indicator, starting from the presentation position of the user indicator and pointing to the presentation position of the target indicator, in response to determining that the user is currently speaking based on the portion of the real-time audio stream corresponding to the user.

In some optional implementations of this embodiment, the dynamic indicator includes a dynamic text stream generated based on text information of content being spoken by the user currently.

In some optional implementations of this embodiment, the apparatus 600 further includes: a text box presentation unit configured to add a text box corresponding to the user in the voice interaction interface, where the text box is used to present text information of the portion of the real-time audio stream corresponding to the user.

In some optional implementations of this embodiment, the second position includes a position where a sound collection device is arranged in the physical environment or a position where a target user is located in the physical environment.

This embodiment exists as an apparatus embodiment corresponding to the above method embodiment. The apparatus for interacting voice based on a large language model according to this embodiment determines a user included in a physical environment and a first position of each user in the physical environment based on a real-time audio stream collected in the physical environment; presents a user indicator corresponding to the user in association with a target indicator in a voice interaction interface rendered for the physical environment, where the relative positional relationship between the user indicator and the target indicator is determined based on the relative positional relationship between the first position and a second position corresponding to the target indicator in the physical environment; adjusts a visual presentation attribute of the user indicator based on a portion of the real-time audio stream corresponding to the user. Thus, users can more intuitively and conveniently understand the interaction status and situation between users in a meeting, reducing the interaction complexity for users and improving the user experience.

According to the embodiments of the present disclosure, the present disclosure further provides an electronic device, a readable storage medium, and a computer program product.

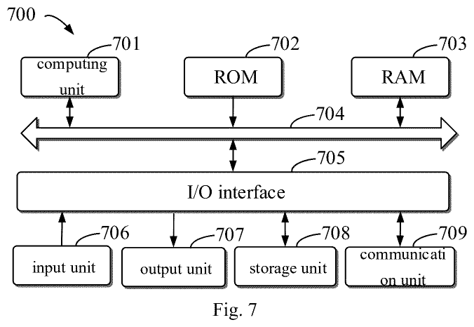

FIG. 7 shows a schematic block diagram of an exemplary electronic device 700 that may be used to implement the embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as personal digital processing, cellular phones, smart phones, wearable devices, and other similar computing devices. The components shown herein, their connections and relationships, and their functions are merely examples, and are not intended to limit the implementations of the present disclosure described and/or required herein.

As shown in FIG. 7, the device 700 includes a computing unit 701, which can execute various appropriate actions and processes according to a computer program stored in a read-only memory (ROM) 702 or a computer program loaded from a storage unit 708 into a random access memory (RAM) 703. In the RAM 703, various programs and data required for the operation of the device 700 are also stored. The computing unit 701, the ROM 702, and the RAM 703 are connected to each other through a bus 704. An input/output (I/O) interface 705 is also connected to the bus 704.

Multiple components in the device 700 are connected to the I/O interface 705, including: an input unit 706, such as a keyboard and a mouse; an output unit 707, such as various types of displays and speakers; a storage unit 708, such as a magnetic disk and an optical disk; and a communication unit 709, such as a network card, a modem, and a wireless communication transceiver. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, a central processing unit (CPU), a graphics processing unit (GPU), various dedicated artificial intelligence (AI) computing chips, various computing units running machine learning model algorithms, a digital signal processor (DSP), and any appropriate processor, controller, and microcontroller. The computing unit 701 executes the various methods and processes described above, such as the method for interacting voice based on a large language model. For example, in some embodiments, the method for interacting voice based on a large language model may be implemented as a computer software program tangibly embodied in a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the computing unit 701, one or more steps of the method for interacting voice based on a large language model described above may be executed. Alternatively, in other embodiments, the computing unit 701 may be configured to execute the method for interacting voice based on a large language model in any other suitable manner (for example, by means of firmware).

The various implementations of the systems and technologies described herein may be implemented in digital electronic circuit systems, integrated circuit systems, field-programmable gate arrays (FPGAs), application-specific integrated circuits (ASICs), application-specific standard products (ASSPs), systems-on-a-chip (SOCs), complex programmable logic devices (CPLDs), computer hardware, firmware, software, and/or combinations thereof. These various implementations may include: being implemented in one or more computer programs that can be executed and/or interpreted on a programmable system including at least one programmable processor, which may be a dedicated or general-purpose programmable processor, and can receive data and instructions from a storage system, at least one input device, and at least one output device, and transmit data and instructions to the storage system, the at least one input device, and the at least one output device.

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor that may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more wire-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user may provide input to a computer. Other types of devices may also be used to provide interaction with a user; for example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

A computer system may include a client and a server. The client and the server are generally remote from each other and typically interact via a communication network. The client-server relationship is generated by computer programs running on respective computers and having a client-server relationship with each other. The server may be a cloud server, also known as a cloud computing server or cloud host, which is a host product in the cloud computing service system. It addresses the drawbacks of high management difficulty and weak business scalability existing in traditional physical hosts and Virtual Private Server (VPS) services.

According to the technical solution of the embodiments of the present disclosure, the user included in the physical environment and their first positions in the physical environment are determined based on the real-time audio stream collected in the physical environment; user indicators corresponding to the users are presented in association with a target indicator in the voice interaction interface rendered for the physical environment, where the relative positional relationship between each user indicator and the target indicator is determined based on the relative positional relationship between the first position and the second position corresponding to the target indicator in the physical environment; and the visual presentation attributes of the user indicators are adjusted based on the portions of the real-time audio stream corresponding to the respective users. Thus, users can more intuitively and conveniently understand the interaction status and situation between users in a meeting, the interaction complexity for users is reduced, and the user experience is improved.

It should be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for interacting voice based on a large language model, comprising:
determining a user included in a physical environment and a first position of the user in the physical environment based on a real-time audio stream collected in the physical environment;
presenting a user indicator corresponding to the user and being associated with a target indicator in a voice interaction interface rendered for the physical environment, wherein a relative positional relationship between the user indicator and the target indicator is determined based on a relative positional relationship between the first position and a second position corresponding to the target indicator in the physical environment; and
adjusting a visual presentation attribute of the user indicator based on a portion of the real-time audio stream corresponding to the user.

2. The method according to claim 1, wherein the determining a user included in a physical environment and a first position of the user in the physical environment based on a real-time audio stream collected in the physical environment comprises:
determining a source direction and a distance of a voice signal in the real-time audio stream collected in the physical environment using a time difference of arrival positioning algorithm;
determining the user included in the physical environment based on the source direction; and
determining the first position of the user in the physical environment based on the distance.

3. The method according to claim 1, further comprising:
parsing text information of the portion of the real-time audio stream corresponding to the user;
determining identity information corresponding to the user based on the text information; and
presenting an identity prompt in association with the user indicator corresponding to the user based on the identity information corresponding to the user.

4. The method according to claim 3, further comprising:
in response to determining that a same user is identified with at least two different pieces of identity information, merging the at least two different pieces of identity information and portions of the real-time audio stream used to determine the at least two different pieces of identity information.

5. The method according to claim 4, further comprising:
combining text information corresponding to a first user and text information corresponding to a second user to obtain combined text information, wherein the identity information corresponding to the first user is different from the identity information corresponding to the second user; and
performing context analysis on the combined text information using a large language model to obtain a context analysis result, wherein the context analysis result indicates whether the first user and the second user are the same user with different identity information.

6. The method according to claim 1, further comprising:
presenting the target indicator at a center of the voice interaction interface.

7. The method according to claim 1, further comprising:
forming the voice interaction interface based on a planar layout of the physical environment.

8. The method according to claim 7, further comprising:
determining a planar position of the second position in the planar layout; and
presenting the target indicator in the voice interaction interface based on the planar position.

9. The method according to claim 1, wherein the adjusting the visual presentation attribute of the user indicator based on the portion of the real-time audio stream corresponding to the user comprises:
continuously adjusting a size of the user indicator based on an accumulated number of words of the text information of the portion of the real-time audio stream corresponding to the user, wherein the size is positively correlated with the accumulated number of words.

10. The method according to claim 9, further comprising:
in response to the accumulated number of words being greater than or equal to an accumulation threshold, stopping continuously adjusting the size of the user indicator.

11. The method according to claim 1, wherein the adjusting the visual presentation attribute of the user indicator based on the portion of the real-time audio stream corresponding to the user comprises:
adjusting a size of the user indicator based on a volume of the portion of the real-time audio stream corresponding to the user, wherein the size is positively correlated with the volume.

12. The method according to claim 1, wherein the adjusting the visual presentation attribute of the user indicator based on the portion of the real-time audio stream corresponding to the user comprises:
continuously adjusting a presentation position of the user indicator to move toward the target indicator based on an accumulated number of words of the text information of the portion of the real-time audio stream corresponding to the user, wherein a moving distance of the presentation position of the user indicator is positively correlated with the accumulated number of words.

13. The method according to claim 12, further comprising:
in response to the presentation position of the user indicator being the same as a presentation position of the target indicator, stopping continuously adjusting the presentation position of the user indicator to move toward the target indicator.

14. The method according to claim 12, further comprising:
in response to determining that the user indicator overlaps the target indicator, stopping continuously adjusting the presentation position of the user indicator to move toward the target indicator.

15. The method according to claim 1, wherein the adjusting the visual presentation attribute of the user indicator based on the portion of the real-time audio stream corresponding to the user comprises:
in response to determining that the user is currently speaking based on the portion of the real-time audio stream corresponding to the user, adjusting a visual style of the user indicator to a dynamic icon.

16. The method according to claim 1, further comprising:
in response to determining that the user is currently speaking based on the portion of the real-time audio stream corresponding to the user, presenting a dynamic indicator starting from a presentation position of the user indicator and pointing to a presentation position of the target indicator, between the user indicator and the target indicator.

17. The method according to claim 16, wherein the dynamic indicator comprises a dynamic text stream generated based on text information of content being spoken by the user currently.

18. The method according to claim 1, wherein the second position comprises a position where a sound collection device is arranged in the physical environment or a position where a target user is located in the physical environment.

19. An electronic device, comprising:
at least one processor; and
a memory communicatively connected to the at least one processor;
wherein the memory stores instructions executable by the at least one processor, and the instructions are executed by the at least one processor to enable the at least one processor to perform operations comprising:
determining a user included in a physical environment and a first position of the user in the physical environment based on a real-time audio stream collected in the physical environment;
presenting a user indicator corresponding to the user and being associated with a target indicator in a voice interaction interface rendered for the physical environment, wherein a relative positional relationship between the user indicator and the target indicator is determined based on a relative positional relationship between the first position and a second position corresponding to the target indicator in the physical environment; and
adjusting a visual presentation attribute of the user indicator based on a portion of the real-time audio stream corresponding to the user.

20. A non-transitory computer-readable storage medium storing computer instructions, wherein the computer instructions are configured to cause a computer to perform operations comprising:
determining a user included in a physical environment and a first position of the user in the physical environment based on a real-time audio stream collected in the physical environment;
presenting a user indicator corresponding to the user and being associated with a target indicator in a voice interaction interface rendered for the physical environment, wherein a relative positional relationship between the user indicator and the target indicator is determined based on a relative positional relationship between the first position and a second position corresponding to the target indicator in the physical environment; and
adjusting a visual presentation attribute of the user indicator based on a portion of the real-time audio stream corresponding to the user.
